(19) United States
(12) Patent Application Publication
(10) Pub. No.: US 2006/0000317 A1
(43) Pub. Date: Jan. 5, 2006

(54) Selective one-way wrench

(76) Inventor: Terence Chen, Yi Lan Hsien (TW)

Correspondence Address: BIRCH STEWART KOLASCH & BIRCH, PO BOX 747, FALLS CHURCH, VA, 22040-0747, US

(21) Appl. No.: 10/902,830

(22) Filed: Aug. 2, 2004

(30) Foreign Application Priority Data
Jun. 30, 2004 (TW) 93119733

(51) Int. Cl. B25B 13/46

(52) U.S. Cl. 81/63.2

(57) ABSTRACT

A selective one-way wrench includes an annular head comprising a first space defined therein, a second space communicated with the first space and a third space communicated with the second space. A gear is put rotationally in the first space. A transmission is put in the second space for transmitting torque from the annular head to the gear in selective one of two opposite directions. A switch is put in the second space through the third space and connected with the transmission. The transmission prevents the switch from rotating and rocking on the annular head.

### BACKGROUND OF INVENTION

1. Field of Invention

The present invention relates to a selective one-way wrench.

2. Related Prior Art

Referring to FIGS. 10 and 11, a conventional selective one-way wrench 70 includes an annular head 71 and a handle 76 extending from the annular head 71. The annular head 71 includes a circular space 72, a crescent space 73 communicated with the circular space 24 and an aperture 77 communicated with the crescent space 73. A pawl 81 is put in the crescent space 73. The pawl 81 includes a first side and a second side opposite to the first side. A toothed face 84 is formed on the first side of the pawl 81. A recess 85 is defined in the second side. Two concave faces 86 and 87 are formed on the second side. The recess 85 is located between the concave faces 86 and 87. A direction controller 82 is put in the crescent space 73 before the pawl 81. The direction controller 82 includes a rod 88 and two wings 89 and 91 extending from the rod 88. The rod 88 includes a recess 92 defined in the top and a recess 93 defined in a side. A spring 83 includes an end put in the recess 85 of the pawl 81 and an opposite end inserted in a recess 93 of the direction controller 82. An annular gear 74 is put in the circular space 72. The annular gear 74 includes a toothed external face 77 for engagement with the toothed face 84 of the pawl 81 and a toothed internal face 75 for engagement with a bolt or nut. An O-ring 78 is put rotationally on the annular gear 74. The O-ring 79 is put in the circular space 72. The O-ring 79 is secured to the annular head 71 by means of a C-ring 95. A switch 90 is put in the aperture 77. The switch 90 includes a tongue 95 defined therein. The tongue 95 is inserted into the recess through the aperture 77. The switch 90 drives the direction controller 82 so that the wing 89 or 91 is engaged with the concave face 86 or 87 of the pawl 81. The switch 90 is secured to the annular head 71 by means of a C-ring 94.

### SUMMARY OF INVENTION

According to the present invention, a selective one-way wrench includes an annular head comprising a first space defined therein, a second space communicated with the first space and a third space communicated with the second space. A gear is put rotationally in the first space. A transmission is put in the second space for transmitting torque from the annular head to the gear in selective one of two opposite directions. A switch is put in the second space through the third space and connected with the transmission. The transmission prevents the switch from rotating and rocking on the annular head.

The primary advantage of the selective one-way wrench of the present invention over the conventional selective one-way wrench discussed in Related Prior Art is that the transmission prevents the switch from rotating and rocking on the annular head.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings.

FIG. 1 is a perspective view of a selective one-way wrench according to a first embodiment of the present invention.

FIG. 2 is an exploded view of the selective one-way wrench of FIG. 1.

FIG. 3 is a cross-sectional view of the selective one-way wrench of FIG. 1 and shows the selective one-way wrench in a position for driving a bolt or nut clockwise.

FIG. 4 is similar to FIG. 3 but shows the selective one-way wrench in a neutral position.

FIG. 5 is a cross-sectional view of the selective one-way wrench of FIG. 1.

FIG. 6 is an exploded view of a selective one-way wrench according to a second embodiment of the present invention.

FIG. 7 is an exploded view of a selective one-way wrench according to a third embodiment of the present invention.

FIG. 8 is an exploded view of a selective one-way wrench according to a fourth embodiment of the present invention.

FIG. 9 is an exploded view of a selective one-way wrench according to a fifth embodiment of the present invention.

FIG. 10 is an exploded view of a conventional selective one-way wrench.

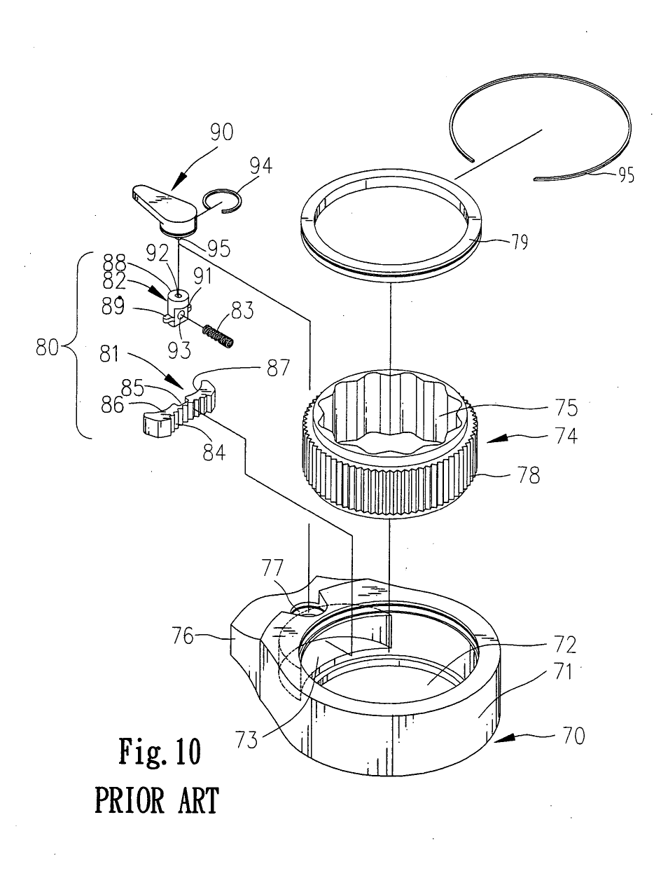

FIG. 11 is a cross-sectional view of the conventional selective one-way wrench of FIG. 10.

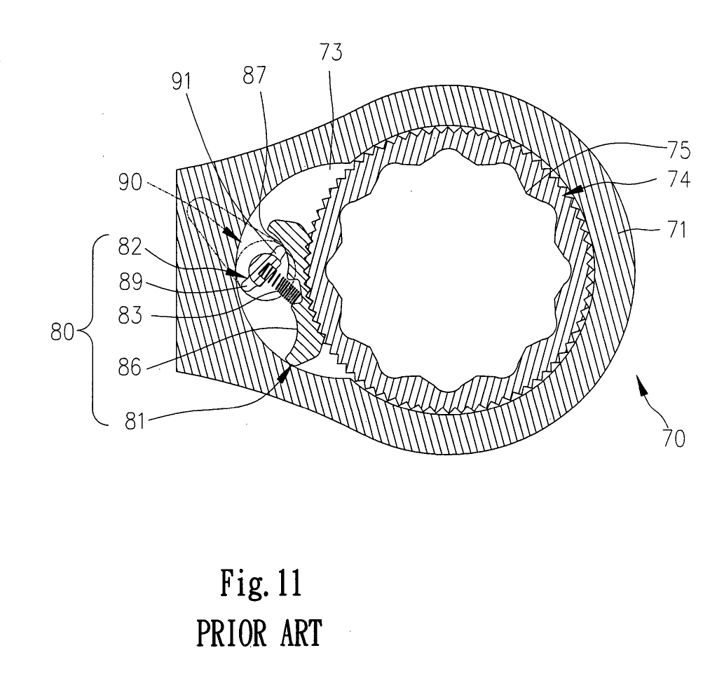

### DETAILED DESCRIPTION OF EMBODIMENTS

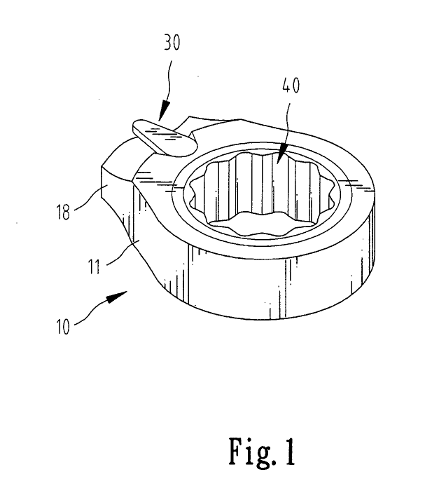

Referring to FIG. 1, according to a first embodiment of the present invention, a selective one-way wrench 10 includes an annular head 11 and a handle 18 (only shown partially) extending from annular head 11.

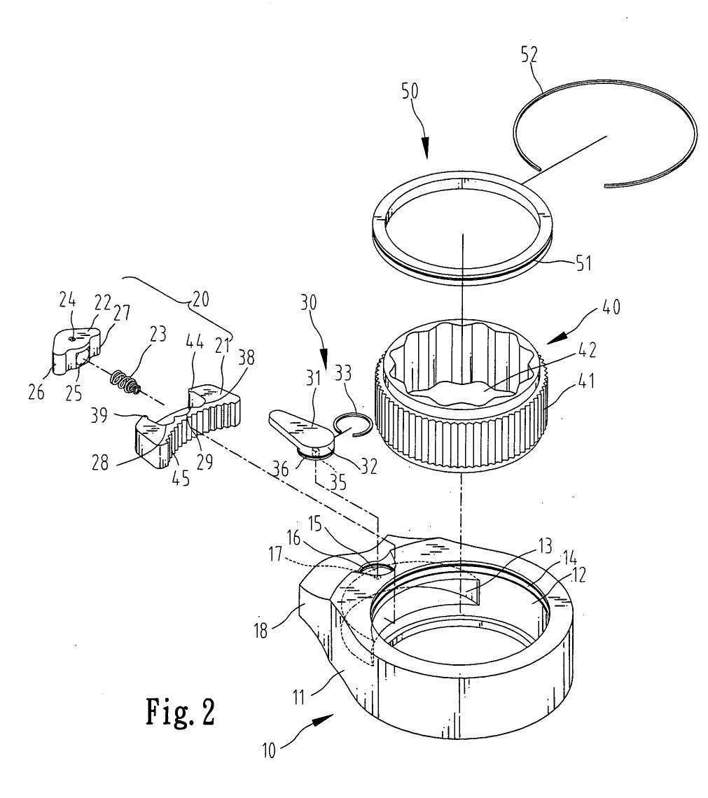

Referring to FIG. 2, the annular head 11 defines a large circular space 12, a crescent space 13 communicated with the large circular space 12, a small circular space 15 and an aperture 17 through which the small circular space 15 is communicated with the crescent space 13. An annular groove 14 is defined in a wall of the large circular space 12. An annular groove 16 is defined in a wall of the small circular space 15.

A transmission 20 is put in the crescent space 13. The transmission 20 includes a pawl 21, a direction controller 22 and a spring 23 for connecting the direction controller 22 with the pawl 21.

The direction controller 22 includes two wings 26 and 27, a groove 24 defined in the top, a recess 25 defined therein. The recess 25 is located between the wings 26 and 27.

The spring 23 includes a first end and a second end opposite to the first end. The first end of the spring 23 is inserted in the recess 25 of the direction controller 22.

The pawl 21 includes a first side and a second side opposite to the first side. Three concave faces 28, 29 and 38 are defined in the first side of the pawl 21. The concave face 29 is located between the concave faces 28 and 38. Two protrusions 39 and 44 are formed on the first side of the pawl 21. The protrusion 39 is adjacent to the concave face 28. The protrusion 44 is adjacent to the concave face 38. The recess 29 receives the second end of the spring 23. The protrusions 25 and 26 are used for restraining the wings 26 and 27 of the direction controller 22. A toothed face 45 is formed on the second side of the pawl 21.

An annular gear 40 is put in the large circular space 12. The annular gear 40 includes a toothed external face 41 for engagement with the toothed face of 45 of the pawl 21 and a toothed internal face 42 for engagement with a bolt or a nut.

An O-ring 50 is rotationally put on the annular gear 40. The O-ring 50 is put in the large circular space 12. The O-ring 50 includes an annular groove 51 defined in external face thereof. A C-ring 52 includes an internal edge put in the annular groove 51 and an external edge-put in the annular groove 14. Thus, the O-ring 50 is firmly attached to the annular head 11 by means of the C-ring 52.

A switch 30 includes a lever 31, a shaft 32 extending from the lever 31, a tongue 35 extending from the shaft 32 and an annular groove 36 defined in the shaft 32. The tongue 35 is inserted into the groove 24 through the small circular space 15. By means of maneuvering the switch 30, the direction controller 22 is rotated so that the wing 26 of the direction controller 22 is engaged with the concave face 28 of the pawl 21 or that the wing 27 of the direction controller 22 is engaged with the concave face 38 of the pawl 21.

A C-ring 33 includes an internal edge put in the annular groove 36 and an external edge put in the annular groove 16. Thus, the switch 30 is firmly attached to the annular head 11 by means of the C-ring 33.

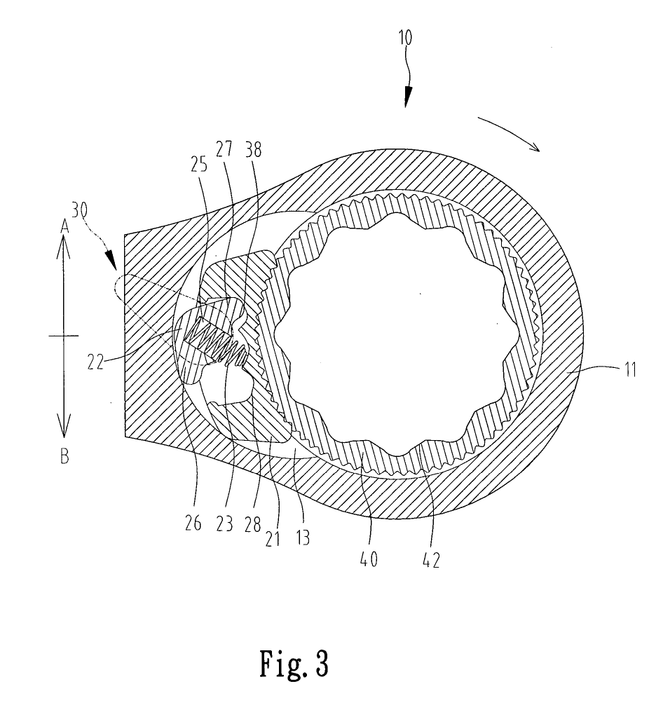

Referring to FIG. 3, the selective one-way wrench 10 can be switched to a first working mode by means of the switch 30. To this end, the switch 30 is rotated clockwise. The direction controller 22 is also rotated. The pawl 21 is moved into a first end of the crescent space 13 by means of the spring 23. A first end of the pawl 21 abuts the wall of the crescent space 31. The wing 27 of the direction controller 22 abuts the concave face 38 of the pawl 21. In the first working mode, the annular head 11 can drive the annular gear 40 clockwise, but not vice versa.

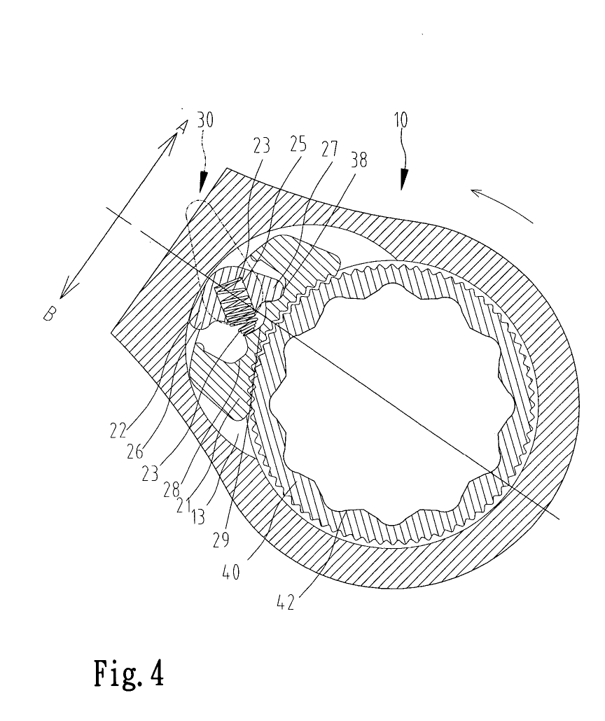

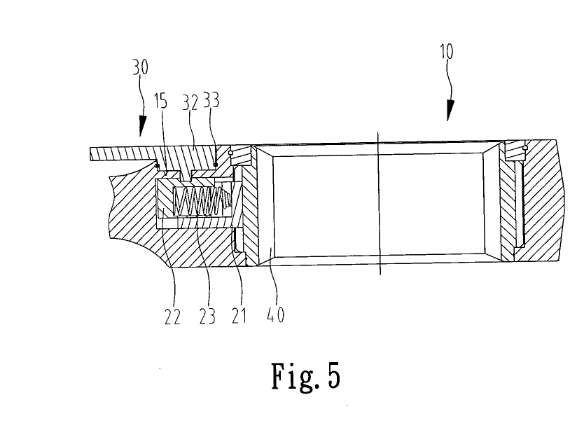

Referring to FIG. 4, the annular head 11 is rotated counterclockwise. In this case, the spring 23 allows the pawl 21 to disengage from the annular gear 40. Thus, the annular head 11 does not drive the annular gear 40 counterclockwise. During the counterclockwise rotation of the annular head 11, the wing 26 of the direction controller 22 abuts the wall of the crescent space 13, and the wing 27 of the direction controller 22 abuts the concave face 38. Thus, the direction controller 22 does not rotate on the annular head 11. Accordingly, the switch 30 does not rotate on the annular head 11. Referring to FIG. 5, the space 15 receives the shaft 32 so that the switch 30 does not rock. Therefore, the switch 30 remains still during the counterclockwise rotation of the annular head 11.

Although not shown, the selective one-way wrench 10 can be switched to a second working mode by means of the switch 30. To this end, the switch 30 is rotated counterclockwise. The direction controller 22 is rotated accordingly. The pawl 21 is moved into a second end of the crescent space 13 by means of the spring 23. A second end of the pawl 21 abuts the wall of the crescent space 31. The wing 26 of the direction controller 22 abuts the concave face 28 of the pawl 21. In the second working mode, the annular head 11 can drive the annular gear 40 counterclockwise, but not vice versa.

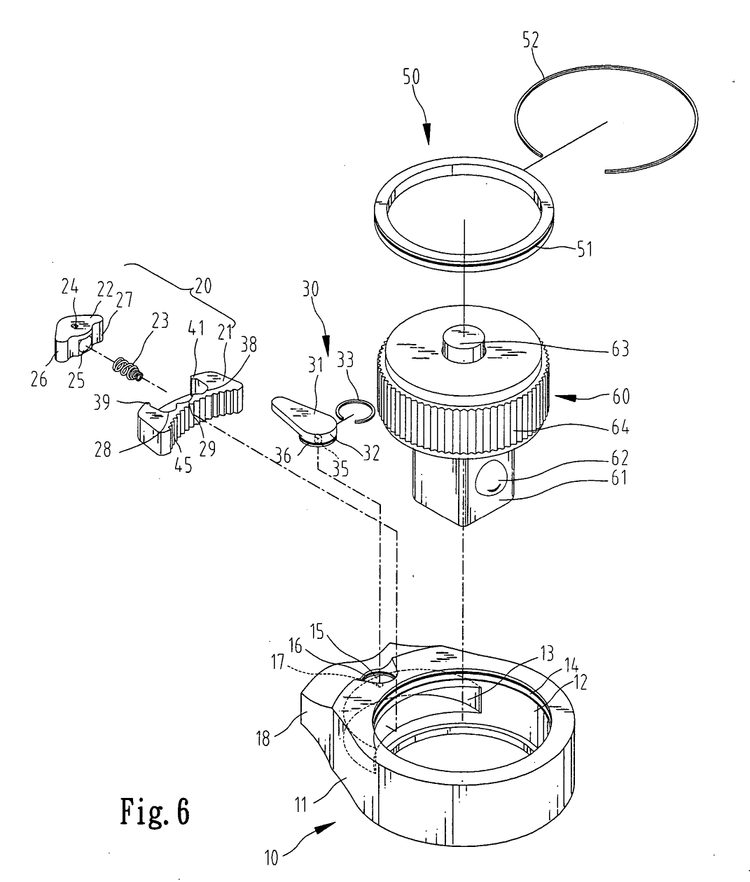

FIG. 6 shows a selective one-way wrench 10 according to a second embodiment of the present invention. The second embodiment is identical to the first embodiment except for including a joint 60 instead of the annular gear 40. The joint 60 includes a hollow insert 61, a detent 62 movably put in the hollow insert 61 and a control element 63 movably put in the hollow insert 61 for pushing the detent 62 from the hollow insert 61.

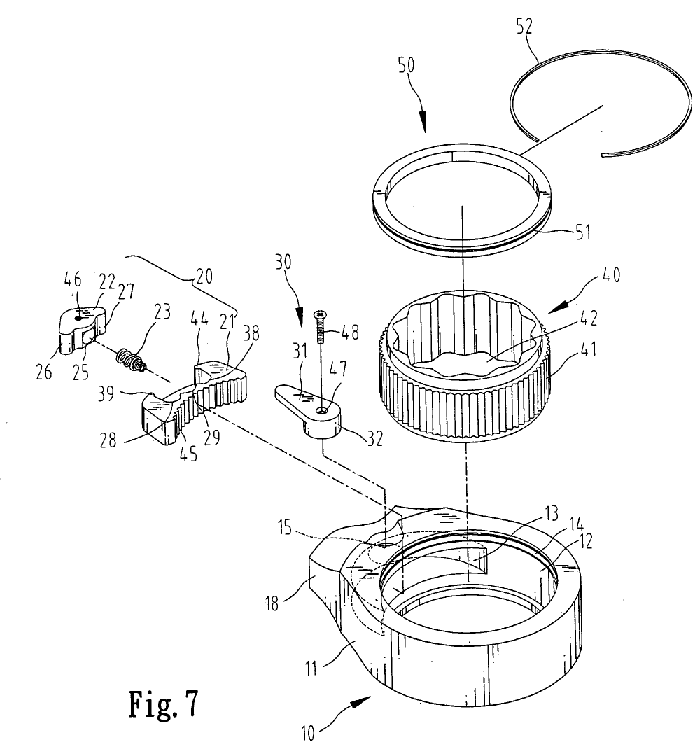

FIG. 7 shows a selective one-way wrench 10 according to a third embodiment of the present invention. The third embodiment is identical to the first embodiment except for a few things. Firstly, a screw hole 46 is defined instead of the groove 24. Secondly, a hole 47 is defined in the shaft 32. The hole 47 is preferably a screw hole. Thirdly, a screw 48 is driven into the screw hole 46 through the screw hole 47. The direction controller 22 can thus be rotated by means of the switch 30. Fourthly, the tongue 35 is saved. Fifthly, the annular groove 36 is saved.

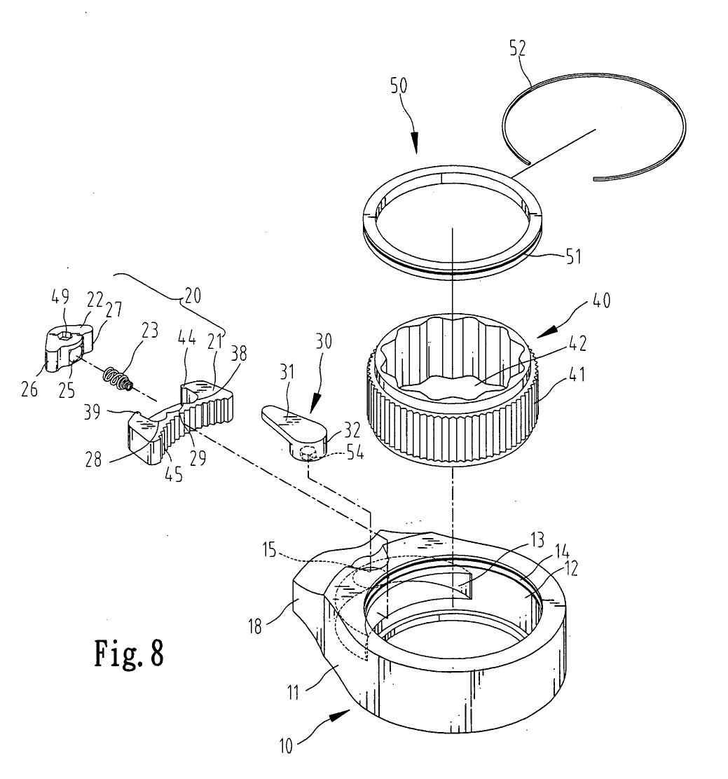

FIG. 8 shows a selective one-way wrench 10 according to a fourth embodiment of the present invention. The fourth embodiment is identical to the first embodiment except for two things. Firstly, a hexagonal tongue 54 is formed instead of the tongue 35. Secondly, instead of the slot 24, a hexagonal recess 73 is defined for receiving the hexagonal tongue 54.

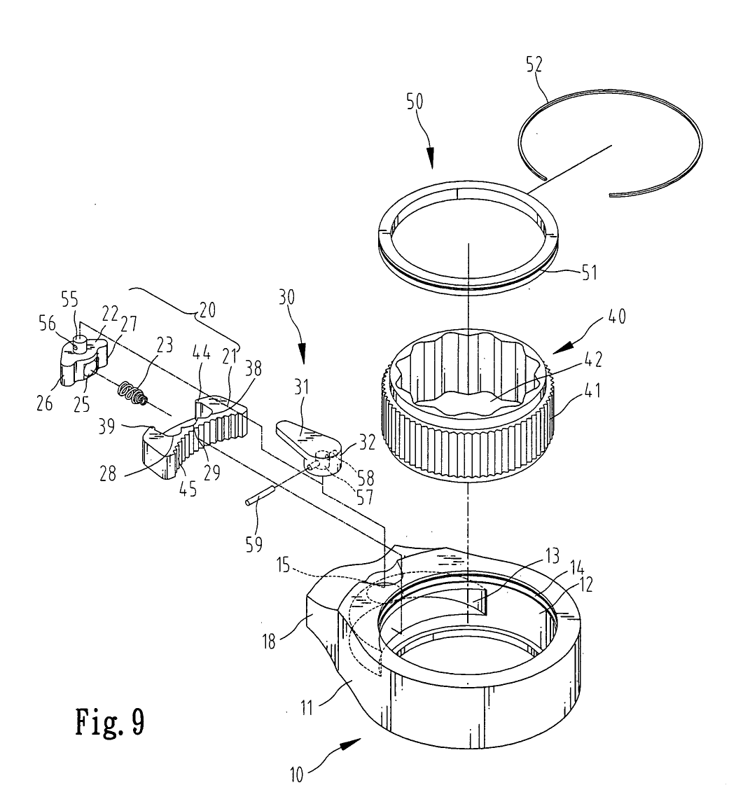

FIG. 9 shows a selective one-way wrench 10 according to a fifth embodiment of the present invention. The fifth embodiment is identical to the third embodiment except for a few things. Firstly, instead of the screw hole 46 defined in the top of the direction controller 22, a rod 55 is formed on the top of the direction controller 22. Secondly, passage 56 is defined in the rod 75. Thirdly, instead of the screw hole 47, a recess 57 is defined for receiving the rod 55. Fourthly, the shaft 32 includes a passage 58 extending laterally through the shaft 32. Fifthly, a pin 59 is inserted into the passage 56 through the passage 58. The direction controller 22 can thus be rotated by means of the switch 30.

The present invention has been described through detailed illustration of the embodiments. Those skilled in the art can derive variation from the embodiments without departing from the scope of the present invention. Therefore, the embodiments shall not limit the scope of the present invention defined in the claims.

1. A selective one-way wrench comprising:
an annular head comprising a first space defined therein, a second space communicated with the first space and a third space communicated with the second space;
a gear put rotationally in the first space;
a transmission put in the second space for transmitting torque from the annular head to the gear in selective one of two opposite directions; and
a switch put in the second space through the third space and connected with the transmission, wherein the transmission prevents the switch from rotating and rocking on the annular head.

2. The selective one-way wrench according to claim 1 wherein the transmission comprises a pawl for engagement with the gear, a direction controller connected with the switch and an elastic element for connecting the direction controller with the pawl.

3. The selective one-way wrench according to claim 2 wherein the gear comprises a toothed face, wherein the pawl comprises a toothed face for engagement with the toothed face of the gear.

4. The selective one-way wrench according to claim 2 wherein the pawl comprises two concave faces, wherein the direction controller comprises two wings selective one of which abuts relative one of the concave faces while the remaining one of the wings abuts the wall of the second space.

5. The selective one-way wrench according to claim 2 wherein the pawl comprises a third concave face for receiving an end of the elastic element.

6. The selective one-way wrench according to claim 2 wherein the direction controller defines a recess in order to receive an end of the elastic element.

7. The selective one-way wrench according to claim 2 wherein the elastic element is a spring.

8. The selective one-way wrench according to claim 2 wherein the pawl comprises two protrusions each extending from corresponding one of the first and second concave faces for confining the first and second wings.

9. The selective one-way wrench according to claim 2 wherein the direction controller comprises a recess defined therein, wherein the switch comprises a tongue extending into the recess of the direction controller.

10. The selective one-way wrench according to claim 9 comprising a C-ring, wherein the switch defines an annular groove for receiving an internal edge of the C-ring, wherein the annular head defines an annular groove in the wall of the third space for receiving an external edge of the C-ring.

11. The selective one-way wrench according to claim 9 wherein the recess is a groove.

12. The selective one-way wrench according to claim 9 wherein the recess is hexagonal.

13. The selective one-way wrench according to claim 9 wherein the switch comprises a shaft from which the tongue extends.

14. The selective one-way wrench according to claim 2 comprising a screw for connecting the switch with the direction controller.

15. The selective one-way wrench according to claim 14 wherein the switch defines a hole, wherein the direction controller defines a hole in which the screw is driven through the hole defined in the switch.

16. The selective one-way wrench according to claim 15 wherein the hole defined in the direction controller is a screw hole.

17. The selective one-way wrench according to claim 15 wherein the hole defined in the switch is a screw hole.

18. The selective one-way wrench according to claim 2 wherein the switch comprises a recess defined therein, wherein the direction controller comprises a rod extending into the recess of the switch.

19. The selective one-way wrench according to claim 18 comprising a pin for securing the switch to the rod of the direction controller.

20. The selective one-way wrench according to claim 19 wherein the rod of the direction controller defines a passage in which the pin is fit.

21. The selective one-way wrench according to claim 20 wherein the switch defines a passage through which the pin is fit in the passage defined in the rod of the direction controller.

22. The selective one-way wrench according to claim 2 wherein the switch comprises a lever operable for the rotation thereof.

23. The selective one-way wrench according to claim 1 wherein the first space is a circular space.

24. The selective one-way wrench according to claim 1 wherein the second space is a crescent space.

25. The selective one-way wrench according to claim 1 wherein the third space is a circular space.

26. The selective one-way wrench according to claim 1 wherein the gear is an annular gear.

27. The selective one-way wrench according to claim 1 wherein the gear comprises an insert for insertion in and rotation of a socket.

28. The selective one-way wrench according to claim 1 comprising a handle projecting from the annular head.

29. The selective one-way wrench according to claim 1 comprising a handle projecting from the annular head.
